(19) United States
(12) Patent Application Publication
(10) Pub. No.: US 2011/0239721 A1
(43) Pub. Date: Oct. 6, 2011

(54) FLUID COOLING DURING HOT-BLOW-FORMING OF METAL SHEETS AND TUBES

(75) Inventors: Jon T. Carter, Farmington, MI (US); Ravi Verma, Shelby Township, MI (US); Paul E. Krajewski, Troy, MI (US)

(73) Assignee: GM GLOBAL TECHNOLOGY OPERATIONS, INC., Detroit, MI (US)

(21) Appl. No.: 12/754,686

(22) Filed: Apr. 6, 2010

(51) Int. Cl. B21D 26/02; B23Q 11/10

(52) U.S. Cl. 72/60; 72/342.2; 72/342.94

(57) ABSTRACT

Metal sheets and thin-wall metal tubes may be heated to a hot working temperature and transformed by a hot-blow-forming step to achieve shapes, difficult to attain, without excessive thinning or strain causing damage to the workpiece based on the inherent formability of the metal alloy. The stages of forming of the intended shape in the metal workpiece are analyzed and workpiece regions of potential damage during forming are identified. Then, during actual forming, these regions of the hot workpiece are selectively cooled with air (or other cooling fluid) to reduce thinning or strain in the critical region(s) and to redistribute this strain to adjacent lower strain areas of the workpiece. This hot-blow-forming practice is particularly useful in attaining complex shapes in workpieces of aluminum-based alloys and magnesium-based alloys.

### TECHNICAL FIELD

This disclosure pertains to the use of a pressurized fluid acting against one side of a heated, thin metal workpiece to push and stretch the heat-softened workpiece. Often the workpiece is stretched into conformance with the forming surface of a tool positioned at the other side of the workpiece to form the metal into a complex shape. More specifically, this disclosure pertains to the use of a second fluid to selectively cool predetermined high-strain locations of the deforming metal to enhance the overall formability of the workpiece and to minimize localized damage as it is being formed.

### BACKGROUND OF THE INVENTION

There is interest in forming thin, relatively light-weight, aluminum-based alloy workpieces and magnesium-based alloy workpieces into automotive body panels or generally tubular body or frame structures, or the like. Such panels may be formed from initially flat, sheet metal blanks having dimensions of, e.g., about 1000 mm×1500 mm×1-3 mm. Tubular structures may be made from tubes of, e.g., necessary length, a nominal diameter of about 50 mm to about 150 mm, or so, and a wall thickness of about 1-3 mm.

In hot-blow-forming of tubular workpieces, a suitably formable metal alloy tube is heated to a forming temperature and placed within a confining tool having one or more forming surfaces, and fluid pressure is applied to the inside of the workpiece, expanding softened thin-wall portions against enclosing forming surfaces of the tool. Complex shapes from the tube workpiece may be obtained.

Hot blow forming of magnesium or aluminum sheet metal typically involves heating of the sheet to approximately 500° C. in a preheat furnace, robotically transferring that sheet to a position between facing die members (sometimes called tools) which are also heated to approximately that same temperature, clamping the sheet between die halves to establish a gas-tight seal, and then applying gas pressure to one side of the sheet to blow it and stretch it into conformance with a facing die cavity to form the desired shape. The gas pressure is then released, the dies are opened, and the formed panel is removed and allowed to cool. Alternatively, in some cases, instead of using a preheat furnace, the sheet may be heated by the hot die. In either case, the sheet is typically heated to approximately 500° C., and then held at that temperature for a short time to assure uniform temperature prior to application of the forming pressure. The workpiece typically (if not already fully annealed) undergoes static recrystallization before deformation, and it is the recrystallized grain structure that experiences the deformation. This practice may be successfully used with aluminum alloys and magnesium alloys of suitable composition and thermomechanical history. Vehicle body panels with complex curvatures and deep depressions or pockets may be formed.

Thus, hot-blow-forming may be used to form complex three-dimensional shapes depending upon the formability of all regions of the metal workpiece as it is stretched over and against the forming surfaces of the heated forming tool. Lubricants may be used to enhance the frictional movement of the metal over the shaping tool surfaces and to protect surfaces of the workpiece and tool. Still, there may be limitations in the desired article shapes obtainable from a specified sheet metal alloy.

### SUMMARY OF THE INVENTION

Hot-blow-forming is generally practiced on thin, metal alloy workpieces such as sheet metal or metal tubes where the cold rolled or extruded metal is often about one to about three millimeters in thickness. In illustrations of embodiments of the invention in this specification, reference will often be made to the processing of sheet metal workpieces. This is done for purposes of simplification and with the understanding that, in many embodiments, the thin metal of tubular workpieces may be processed in a like manner.

Since hot-blow-forming is often used to deform thin metal alloy workpieces into articles of complex shapes, a suitable metal alloy composition and metallurgical microstructure must be selected. For example, Aluminum Alloy 5083 may be suitable for aluminum alloy articles and AZ31 is often suitable for magnesium alloy articles. Each may be prepared with a fine-grain microstructure that provides improved ductility for forming. As described above, the workpiece is heated, generally uniformly, to a predetermined forming temperature, before or after it is placed between heated forming dies. This heating process may also be used to anneal or recrystallize the workpiece, enhancing its formability just as the hot-blow-forming operation is started. Often, the dies (or other forming tools) are also heated to a relatively narrow forming temperature range, established to enhance the formability of the workpiece within an acceptable forming period.

The shape of the part to be formed is analyzed to identify regions in which the sheet metal workpiece may experience strain levels that could result in tearing or other damage to the sheet metal as it is stretched and formed, even at the elevated forming temperatures of the metal. For example, one may wish to from a hemispherical shape in a metal workpiece. When the periphery of a preheated sheet metal specimen is clamped and suitable air pressure applied to one side, the hot sheet may be gradually expanded into a hemispherical dome shape. But it is observed that the dome height of the expanding metal is often limited by excessive thinning and splitting of the strained metal near the pole region of the forming dome shape. A hemispherical shape is a relatively simple shape to analyze. But other forming tests may be conducted by analytical techniques or by preliminary forming experiments on a workpiece material to analyze other desired article shapes. Such tests are conducted for the purpose of identifying regions of an intended shape in which the metal may be excessively thinned, or over-strained and damaged before a desired, hot-blow-formed article shape is attained.

Sometimes such localized thinning and straining of the ductile metal limits the types of shapes (for example, the dome heights) that can be attained by hot-blow-forming of the material. This may mean that a desired article shape cannot be made from available metal alloys using hot-blow-forming. Sometimes the shape may still be attained by markedly slowing the application of fluid pressure and the rate of forming. But this limits production rates and the utilization of expensive forming equipment.

In accordance with embodiments of the invention, identified regions of a thin metal workpiece, which has been heated more or less uniformly to its forming temperature, are selectively cooled during a hot-blow-forming process. The cooling is suitably accomplished by directing a stream of ambient air (or other suitable fluid) against one or both of the sides of the metal in the identified surface regions of the workpiece. The cooling fluid stream is used and controlled to reduce the strain and thinning of the forming metal in the identified, critical forming regions. This reduction in straining or thinning is a consequence of the metal in the cooled region becoming harder. The selected cooling strategy is to shift the strain into larger adjacent areas of the thinning metal workpiece as it undergoes the forming operation, and enhance the overall formability through more uniform thinning of the workpiece. This shifting of the strain permits the workpiece to achieve the intended shape of the forming step that it is experiencing.

Depending on predetermined requirement for the metal and the forming step, one or several streams of cooling fluid may be used to selectively cool one or more highly strained regions of the workpiece. The cooling fluid streams may be directed against the selected regions of the hot workpiece during selected portions of the hot-blow-forming step or during the entire period of the forming step. A hot-blow-forming step for a metal workpiece may, for example, take thirty to more than one-hundred seconds to complete, and cooling fluid streams may be applied to regions of the metal during selected portions of the forming period, or during the entire period. Some articles may require more than one hot-blow-forming step and selected cooling may be used in one or more of the forming steps.

Thus, in accordance with practices of the invention, the hot-blow-forming process uses two fluid streams. One fluid, which may be air, is used to pressurize and form the heated metal workpiece against a shaping surface. The second fluid, which may also be air, is used to locally cool selected regions of the workpiece as it is shaped. The cooling stream or streams are used to permit the hot-blow-forming of more complex shapes in a metal workpiece and to accomplish such forming in relatively short forming periods of a minute or so.

Other objects and advantages of the invention will be apparent form the following specific illustrative examples of practices of the invention. Reference will be had to drawing figures which are described in the following section of this specification.

### BRIEF DESCRIPTION OF THE DRAWINGS

FIG. 1 is a schematic view of a lateral cross-section of hot-blow-forming apparatus for forming a decklid inner panel for an automotive vehicle from an aluminum alloy sheet or a magnesium alloy sheet. The location of the FIG. 1 cross-section with respect to the shape of the formed and trimmed panel is indicated at line A-B in FIG. 2.

FIG. 2 is an oblique view of a trimmed and finished vehicle decklid inner panel as initially hot-blow-formed by the apparatus and process exemplified in FIG. 1.

FIG. 3 is a side elevation view of a sheet metal workpiece positioned over a second embodiment of a hot-blow-forming die for shaping two identical deep pockets in the sheet metal. The complementary die member for confining the pressurized forming fluid is not shown to simplify the illustration. In this embodiment, the pockets to be formed in the workpiece are equally offset from a centerline of the sheet.

FIG. 4 is a partial side elevation view of the sheet and forming die of FIG. 3 after the sheet has been partially stretched into the pocket of the die. Cooling air passages in the die permit streams of cooling air to be directed against regions of the sheet as the sheet is being stretched over convex pocket forming portions of the die.

FIG. 5 is another partial side elevation of the sheet and forming die of FIG. 3 showing further shaping of the sheet metal workpiece into conformance with the die surface. Additional streams of cooling air are being supplied to the sheet in the final stages of the forming process.

### DESCRIPTION OF PREFERRED EMBODIMENTS

This invention is especially useful in hot-blow-forming of light metal alloys such as aluminum-based alloys and magnesium based alloys which to not tend to be as formable as low carbon steel alloys. Some exemplary materials suitable for practice of hot-blow-forming include aluminum alloy AA5083 (composition in percentage by weight: Mg, 4.0-4.9; Mn, 0.4-1.0; Zn≦0.25; balance aluminum) and magnesium alloy AZ31B (composition in percentage by weight: Al, 2.5-3.5; Zn, 0.6-1.4; Mn, ≧0.2, balance magnesium). The AZ31 magnesium alloy may be hot-blow-formed in both the annealed (AZ31B—O) and half hard (AZ31B-H24) conditions.

Hot-blow-forming is a forming process in which a heated workpiece, typically in the form of a cold-rolled sheet or a tube, is progressively deformed by maintaining a pressure differential through the workpiece thickness for some period of time, typically ranging from 30 to 300 seconds. The deformation will be accompanied by the accumulation of strain, both in the plane of the workpiece and through its thickness. Hot-blow-forming is a stretch forming process which promotes the accumulation of tensile strains in the plane of the sheet resulting in a reduction in the thickness of the workpiece as deformation proceeds.

Hot-blow-forming is usually accomplished by application of a pressurized fluid, frequently air, to one surface of the workpiece while maintaining a lower pressure on the opposing surface of the workpiece. If conducted in a die, the sheet or tube will initially bulge unrestrained and expand outwardly until the opposing surface of the expanding sheet or tube contacts a shaped die surface. Thereafter, continued expansion of the sheet will induce it to conform to and adopt the die surface geometry.

It is known in hot-blow-forming that the maximum overall shape change in the workpiece is attained when all regions of the workpiece deform equally and the strain in the workpiece is everywhere the same. This goal is not usually achieved in practice despite strategies such as varying the fluid pressure according to a pre-determined schedule during the process and liberal application of lubricant. Instead a non-uniform strain distribution develops in which some regions have deformed to a greater extent than others. Once a non-uniform strain distribution is established, the magnitude of the non-uniformity, that is the difference between the lowest and highest workpiece strains, increases with increasing deformation. Eventually the most highly-deformed region, which as discussed earlier will also be the thinnest region, will split or tear, releasing the pressurized fluid and terminating the forming process.

It is preferred to conduct hot blow forming at elevated temperature. It is known the aluminum and magnesium alloys used in practice of this process possess superior ductility or formability at temperatures above ambient temperatures (about 25° C. or so). More importantly, it is also known that deformation at such elevated temperature is more effective in suppressing the growth of any strain non-uniformity than deformation at ambient temperatures. Nonetheless, as just discussed, once a non-uniform strain distribution initiates or, stated alternatively, a strain gradient develops, eventual rupture of the workpiece may follow. Of course, the transformation of flat sheets or of tubes to relatively simple shapes may be readily practiced without rupture of the workpiece since only limited deformation of the sheet or tube may be required. However there is often need to make complex shapes and it is preferred to be able to conduct hot-blow-forming in a manner which maximizes the shape change while forestalling premature failure.

Most metals, including magnesium and aluminum and their alloys, not only exhibit an increase in their formability at elevated temperatures but also a reduction in their flow strength, that is the applied stress which will lead to plastic or irrecoverable deformation. It is proposed to exploit this behavior to inhibit the growth of a strain non-uniformity.

In a uniformly-loaded metal sheet, such as results from application of pressure by a fluid, the stress applied by the fluid will be greatest in the thinnest region of the sheet. If the flow stress of the sheet is everywhere the same, as will occur in a sheet at a uniform temperature, the flow stress of the sheet will be attained first in that thinnest region promoting additional deformation and yet further thinning. Alternatively, if the flow stress of the sheet varies with location in the sheet then the location at which the fluid-applied stress will first produce plastic deformation in the sheet will depend on both the flow stress and the sheet thickness at each location.

Thus, the distribution of plastic deformation and the development of strain non-uniformities may be managed and controlled by controlling the flow stress of the workpiece through control of the local workpiece temperature, specifically by locally cooling high strain regions of the workpiece. A number of approaches may be employed to selectively and locally cool the workpiece but a simple, direct and effective approach is to apply a cooling fluid to the opposing surface of the workpiece. The fluid may be liquid or gas, but gas is preferred since it more readily affords control over the degree of cooling and thus greater control over the local sheet temperature. Excessive cooling could strengthen too large a region of the workpiece and induce rather than mitigate the development of strain gradients.

Often such control is initiated only after some deformation has occurred so that full advantage may be taken of the beneficial influence of a uniform initial temperature. But for some part geometries and deformation sequences it may be advantageous to selectively apply such cooling fluid from the outset of deformation.

Identification of high strain regions of the workpiece may be readily made experimentally using methods known to those skilled in the art such as circle-gridding the workpiece prior to forming to enable developing a strain map of the formed part, or, even simpler, by recording the location of the failure site. Such an approach, though feasible, would entail making modifications to a die after it has been constructed. A preferred approach is to take advantage of the advances in the modeling of hot-blow-forming, for example using finite element approaches, to identify critical areas of the workpiece by modeling. Since modeling may be performed using only preliminary die design data it may be conducted even before die fabrication is undertaken, enabling any fluid cooling features to be optimally integrated into the die. Such an approach has other advantages: it more precisely defines the onset and growth of a strain non-uniformity and therefore more precisely suggests when cooling should be undertaken; it locates the site of the initial non-uniformity rather than the eventual failure site; and it enables evaluation of combination strategies such as selective cooling undertaken in conjunction with various pressure profiles.

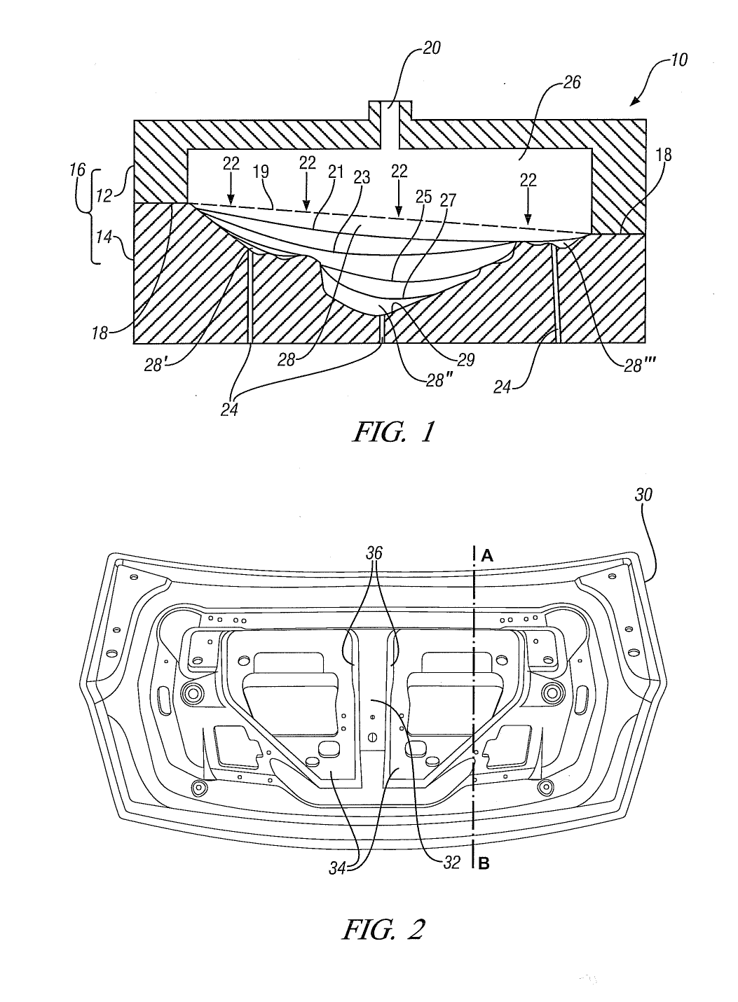

Practices of the invention may be more readily understood by reference to the drawing figures. FIG. 1 is a lateral cross-section of a hot-blow-forming apparatus 10 for forming a decklid inner panel like that shown in FIG. 2. Hot-blow-forming apparatus 10 consists of a die set 16 comprising upper die section 12 and lower die section 14. Such die sections are often formed of a cast tool steel composition with forming surfaces, mating surfaces, and the like, formed by machining. Both die sections 12, 14 of die set 16 may be maintained at an elevated temperature. For example, electrical resistance heating rods (not shown in the figure) may be inserted in drilled holes at suitable locations in the dies for controlled heating of the dies to a desired temperature range for the intended hot-blow-forming step.

Upper and lower die sections 12 and 14 engage the periphery of a heated workpiece, shown in ghost as 19, at die perimeter or binder locations 18 which incorporate suitable sheet metal-contacting, binding features (not shown) for establishing a gas tight seal. Thus, prior to forming, the interior cavity formed by dies 12 and 14 is divided, by heated workpiece 19, into two non-communicating heated volumes 26 and 28.

Lower die section 14 has a shaped face 29 against which a suitable magnesium or aluminum alloy sheet workpiece will be expanded and strained under the influence of a pressurized gas. The pressurized gas (typically air) introduced into upper die section 12 and cavity 26 at opening 20, is indicated as acting on one side of workpiece 19 by arrows 22. Under the influence of the pressurized gas, heated workpiece 19 will deform and be directed into progressive contact with shaped face 29 of lower die 24, adopting a series of configurations, variously shown as 21, 23, 25 and 27, as it does so. As workpiece 19 is stretched and deformed toward shaped face 29, expanding the volume of cavity 26, cavity 28 will be reduced in volume. The gas originally occupying volume 28 is released through suitably-positioned vents 24 placed to enable access to volume 28 even as workpiece 19, as for example at 27, progressively contacts shaped surface 29 and progressively subdivides cavity 28 into sub-cavities 28′, 28″ and 28′″.

At the conclusion of the process, when workpiece 19 conforms fully to shaped surface 29, the pressure in cavity 26 is released, die set 16 is opened and the formed part is removed. At least any material engaging die binder portions 18 will be trimmed or removed. Further processing may include punching holes or openings and forming flanges on the part perimeter to produce finished part 30 (FIG. 2) such as a vehicle inner decklid panel.

Of particular note in part 30 are three centrally located features. These are two concave depressions 34 joined to surrounding elevated regions, typified by central rib 32, by near-vertical walls 36. Such geometries commonly occur in formed sheet metal parts and may significantly influence fracture and rupture of the workpiece.

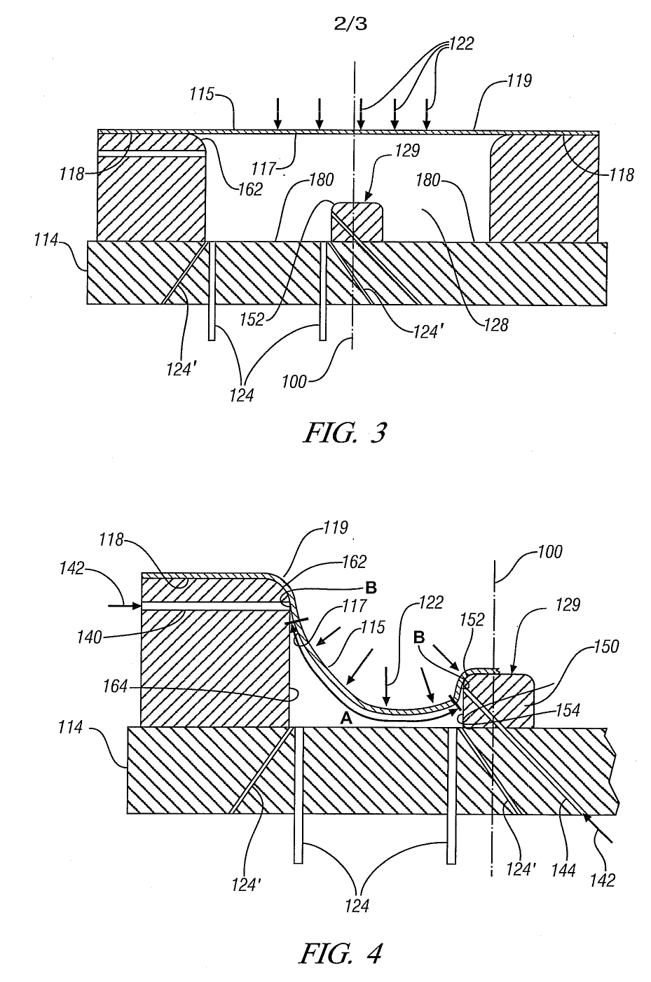

In order to further focus on the forming a combination of severe convex and concave shapes in a sheet metal workpiece, reference is made to FIGS. 3-5 in which two closely spaced, deep pockets are formed in a different workpiece from that illustrated in FIGS. 1 and 2.

FIG. 3 is a side elevation view of a heated aluminum or magnesium alloy sheet workpiece 119 located on binder portions 118 of a lower die portion 114. The aluminum or magnesium alloy is suitable for hot-blow-forming.

The upper tool portion is not shown in FIGS. 3-5. This upper tool serves to confine the pressurized hot-blow-forming fluid and presses the sheet metal workpiece against lower tool 114 at binder region 118.

Lower die portion 114 has a shaped surface 129 intended for forming two identical deep pockets. In this example, the pockets are equally offset from a centerline 100 of the sheet. Die portion 114 may be heated with electrical resistance heaters (not shown) or the like to manage the hot blow forming environment. As is typical, shaped surface 129 incorporates both convex, radii 152, 162, and concave, recesses 180, features. Pressure is applied to the upper surface 115 of sheet 119 as indicated by arrows 122.

Analogously to FIG. 1, binder 118 comprises gas sealing features (not shown) thereby establishing a volume 128 vented by vents 124 and 124′ for release of gas initially contained in volume 128 as surface 117 of sheet 119 advances toward shaped surface 129 under the urging of gas pressure 122.

FIG. 4 illustrates a part of the die and sheet configuration of FIG. 3 after some deformation has occurred. It will be appreciated that because of the symmetry of the die 114 about centerline 100, a like configuration will result in the corresponding portion of the die. As shown, applied pressure 122 has successfully urged sheet workpiece 119 into partial contact with convex features, radii 152 and 162, of shaped die surface 129. Particularly, sheet 119 is in contact with features 150 and 160 and more particularly in contact with radii 152 and 162 and a portion of vertical sidewalls 154 and 164. It is known that frictional interaction will occur between contacting surfaces under pressure. Thus, the local contact of sheet surface 117 with radii 152 and 162 and sidewalls 154 and 164 will frictionally constrain sheet 119 from sliding over features 150 and 160.

The effect of constraining sliding of those portions of sheet 119 in contact with features 150 and 160 is to limit the accumulation of any further strain in the contacting regions since any increase in their length (strain) requires motion across shaped die surface 129. Thus, a greater portion of the deformation, that is more strain, must be accommodated by the non-die-contacting portion of sheet 119 generally indicated as segment ‘A’ in FIG. 4. It is known that even within the non-die-contacting portion of sheet 119, further strain accumulation is not uniform and that a greater portion of the strain is accommodated by the region of portion ‘A’ which immediately abuts or is generally tangent to the contacting surface, and identified as ‘B’ on FIG. 4. Thus, it is preferred to minimize further strain accumulation at these locations by introducing cooling fluid, indicated as arrows 142, through inlet ports 144 and 140 to impinge on the non-die-contacting portion ‘A’ of the sheet 119 at locations ‘B’. Such procedure will increase the strength of the sheet in locations ‘B’ relative to the sheet strength over the remainder of sheet section ‘A’ and will therefore promote more uniform deformation throughout the remainder of section ‘A’ and enable more extensive deformation prior to sheet failure or rupture. For maximum effect, the cooling fluid should be applied before excessive thinning has occurred. Preferably as deformation proceeds the changing thickness of the workpiece in that location will be tracked so that when the thickness reaches some pre-determined threshold cooling may be initiated. The pre-determined threshold, in turn will be dictated by the specified minimum thickness requirements of the article under manufacture.

Such practices are intended for local effect on sheet 119 at a specific stage in the forming operation for remediation of a local strain non-uniformity. In the practice of the sheet metal forming arts it is often observed that multiple strain non-uniformities may develop during forming. Also, suppression of a local strain non-uniformity in one region of the deforming sheet may not suppress the development of subsequent strain non-uniformities in other adjacent or non-adjacent regions of the sheet. Frequently such a plurality of local strain non-uniformities will not occur simultaneously but rather will develop sequentially during the forming process.

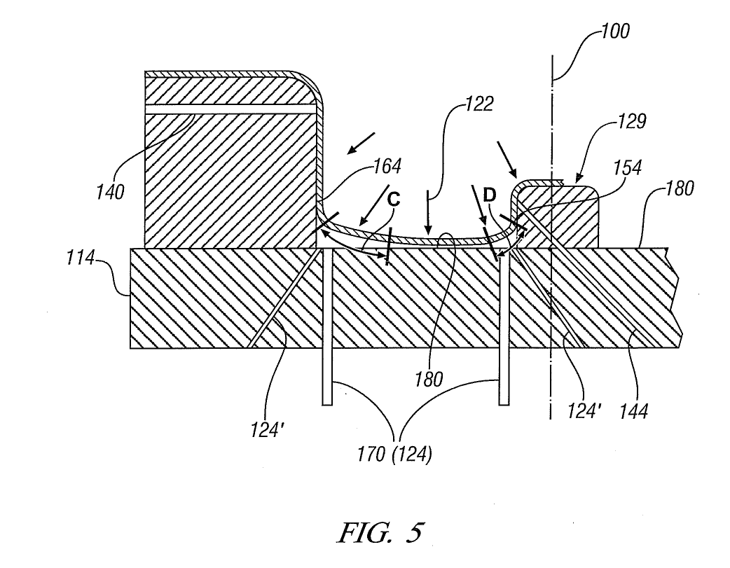

Thus, further deformation, as illustrated at FIG. 5, which has led to yet further contact of sheet 119 with concave features, recesses 180, on shaped surface 129 has further reduced the length of the non-die-contacting portion of sheet 19. Further, the additional deformation has divided the non-die-contacting length into two portions shown as ‘C’ and ‘D’. Analysis and consideration similar to that previously discussed may suggest that improved distribution of strain may result from selectively cooling regions of sheet 119 abutting those regions in contact with vertical wall surfaces 154 and 164. With appropriate valving, vents 124 (FIGS. 3 and 4) may serve a dual role and act, in FIG. 5 as cold air inlets 170 (124) and thereby selectively strengthen portions of the non-die-contacting segments ‘C’ and ‘D’ and enable more uniform deformation to enhance greater forming depths and more uniform part thickness. The line of junction between substantially horizontal and substantially vertical die surfaces will generally be the last portion of the part shaped. Thus, at least some dedicated vents, for example vents 124′, may be positioned in these locations to assure adequate venting of cavity 128 as forming proceeds.

Ambient air is readily available for use as a cooling fluid and is compatible with the environment. The air may be heated or cooled depending on the perceived needs of a cooling requirement. And other fluids may be used, such as carbon dioxide, steam, or an inert gas like helium, if air presents an issue with respect to the metal alloy to be cooled or to the hot-blow-forming environment. In some instances, the addition of a small amount of sulfur hexafluoride to an inert gas cooling stream may reduce oxidation of, for example, a magnesium-based alloy. Other cooling fluids such as methane or fluorinated hydrocarbons may also be considered for use with appropriate safety precautions. And mixtures of different cooling fluids may be used.

The practice of the invention has been illustrated by reference to specific features and elements in an exemplary non-limiting embodiment. It is however intended that the following appended claims and any claims hereafter introduced be interpreted to include any modifications, additions and/or combinations or sub-combinations as are within the spirit and scope of the invention.

1. A method of making an article comprising a shaped portion that is to be formed from a thin-wall tube workpiece or sheet metal workpiece, the workpiece being of a light metal-based alloy composition and metallurgical microstructure for hot blow forming of the thin-wall tube or the sheet metal, the hot-blow-forming of the shaped portion requiring at least one identified region of the workpiece to experience thinning or straining that may damage the formed metal in the identified region; the method comprising:
heating the workpiece, generally uniformly, to a hot-blow-forming temperature for the metal composition and microstructure;
applying pressure of a hot-blow-forming fluid against one side of the metal workpiece to expand at least a portion of the workpiece against the surface of a shaping member positioned on the other side of the workpiece, the shaping surface comprising the shape of the at least one identified region of the workpiece; and, during at least some time during the expansion of the workpiece,
directing a stream of a cooling fluid against at least one side of the workpiece at each identified region to reduce the total strain in that region below a metal failure level, the cooling fluid being a delivered from a different fluid source than the source of the hot-blow-forming fluid.

2. A method of making an article as recited in claim 1 in which the workpiece is a thin metal tube having a tube-wall thickness in the range of about one millimeter to about three millimeters.

3. A method of making an article as recited in claim 1 in which the workpiece is a sheet metal workpiece having a sheet metal thickness in the range of about one millimeter to about three millimeters.

4. A method of making an article as recited in claim 1 in which the workpiece is one of the group of alloys consisting of aluminum alloy AA5083 and magnesium alloy AZ31.

5. A method of making an article as recited in claim 1 in which the cooling fluid is air.

6. A method of making an article as recited in claim 1 in which the cooling fluid is ambient air from the locale of the hot-blow-forming operation.

7. A method of making an article as recited in claim 1 in which the cooling fluid is directed at side of the sheet or tube opposite the side acted upon by the pressurized hot-blow-forming fluid.

8. A method of making an article as recited in claim 1 in which the at least one identified region of the workpiece to experience excessive thinning is identified by experiment.

9. A method of making an article as recited in claim 1 in which the at least one identified region of the workpiece to experience excessive thinning is identified through modeling of the deformation experienced by the article.

10. A method of making an article as recited in claim 1 in which the cooling fluid is directed at the side of the sheet or tube acted upon by the pressurized hot-blow-forming fluid.

11. A method of making an article comprising a shaped portion that is to be formed from a thin-wall tube workpiece or sheet metal workpiece, the workpiece being of a light metal-based alloy composition and metallurgical microstructure for hot blow forming of the thin-wall tube or the sheet metal, the hot-blow-forming of the shaped portion requiring at least one identified region of the workpiece to experience thinning or straining that may damage the formed metal in the identified region; the method comprising:
heating the workpiece, generally uniformly, to a hot-blow-forming temperature for the metal composition and microstructure;
applying pressure of a hot-blow-forming fluid against one side of the metal workpiece to expand at least a portion of the workpiece; and, during at least some time during the expansion of the workpiece,
directing a stream of a cooling fluid against at least one side of the workpiece at each identified region to reduce the total strain in that region below a metal failure level, the cooling fluid being a delivered from a different fluid source than the source of the hot-blow-forming fluid.
